(19) United States
(12) Patent Application Publication
(10) Pub. No.: US 2015/0278892 A1
(43) Pub. Date: Oct. 1, 2015

(54) Methods and Systems Relating to Immediate Service Delivery

(71) Applicant: ePlow Corp., Ottawa (CA)

(72) Inventor: Gustave Roy, Ottawa (CA)

(21) Appl. No.: 14/547,234

(22) Filed: Nov. 19, 2014

Related U.S. Application Data
(60) Provisional application No. 61/969,865, filed on Mar. 25, 2014.

(51) Int. Cl. G06Q 30/06

(52) U.S. Cl. CPC G06Q 30/0611

(57) ABSTRACT

For individuals and enterprises there are many points in their life where it would be beneficial for them to easily and rapidly exploit the power and speed of today electronic devices and communications networks by accessing an online portal/software application allowing for the distribution of their requirements to potential service providers and collation of responses from service providers in multiple formats. However, in contrast to the prior art solutions for supply chain management etc. embodiments of the invention are geared to time sensitive and immediate requirements rather than traditional procurement/order fulfillment cycles. Embodiments of the invention are intended to provide widespread dissemination of requirements and consolidation of responses to the requester.

### CROSS-REFERENCE TO RELATED APPLICATIONS

This patent application claims the benefit of U.S. Provisional Patent Application 61/969,865 filed on Mar. 25, 2014 entitled “Methods and Systems Relating to Immediate Service Delivery.”

### FIELD OF THE INVENTION

This invention relates to service provisioning/requests and more particularly to service provisioning/requests with immediate/short-term requirements.

### BACKGROUND OF THE INVENTION

Service industries, also referred to as the “tertiary industry sector” by economists, involve the provision of services to businesses as well as final consumers. As such, service industries can vary substantially and include, but not limited to, accounting, tradesmanship (e.g. mechanic or plumber services), computer services, restaurants, tourism, etc. Hence, a service industry is one where no goods are produced per se whereas primary industries are those that extract minerals, oil etc. from the ground and secondary industries are those that manufacture products. Some service industries such as catering may essentially sit on the boundary of secondary and tertiary industries as they produce products but are commonly viewed as a service, i.e. a catering service provides specific food and beverages at a customer's request rather than a baker who bakes bread in anticipation of sales as well as to order for hotels, restaurants, etc.

Over the last 100 years, there has been a substantial shift from the primary and secondary sectors to the tertiary sector in industrialised countries, a shift called tertiarisation. The tertiary sector is now the largest sector of the economy in the Western world, and in many instances is also the fastest-growing sector. In the United States in 2010 approximately 84 percent of the work force was employed within tertiary industries and this sector accounted for approximately 80% of the gross domestic profit (GDP) whereas the secondary manufacturing industries in comparison employed approximately 13% of the work force and contributed 15% to the GDP.

Accordingly, over time a large amount of effort, thought, and investment has gone into techniques to allow any tertiary provider to effectively advertise and promote themselves and their services as well as supplying effectively and cost-efficiently. The growth of the Internet has now added additional options including providing websites, online ordering, social networks, automated distribution of special offers and product information, etc. At the same time, the Internet has in some aspects increased the buyer's ability to identify, source, and procure the services and/or products by offering access to providers locally, regionally, nationally and internationally that were not previously feasible.

However, despite these advancements the essential steps of consumer/buyer have remained fundamentally the same when seeking to procure a service and/or product. Basically, they must search, e.g. by visiting physical stores/malls or visiting online in virtual stores/malls, place an order, and await fulfillment of their order for anything that cannot be immediately provided. In this process they may visit physical stores and search online as well as telephoning or emailing particular stores/providers and awaiting responses either in all instances or in sufficient to delay their procurement decision.

This system works well when the requirements have no expediency or time sensitive nature. Considering the routine annual requirement for snow removal/plowing services in Canada and many states of the United States. A householder may search online, using resources such as presented and described below in respect of FIGS. 1, 2A and 2B, and through a combination of email, submitted standard format questionnaires on websites, meetings, and telephone calls obtain a series of quotations from which they pick a provider of the service and engage them for the forthcoming winter. In many instances, the householder may for simplicity and speed simply talk to their neighbours and use the same company which is why whole streets or sections of streets have the same snow plowing service provider. But what happens when they wake up in the morning and need their driveway plowed as their service provider has not completed the task as perhaps they are ill, were in an accident, gone bankrupt, etc. Currently, the householder must repeat the same process and find someone who will, generally knowing that the householder has limited options, charge a fee significantly higher than the norm for the service.

In a similar manner, an individual may find that they are in need of the services of a heating engineer due to a furnace malfunction, a plumber, or a drain cleared. Alternatively, they may need a haircut, a hire car, someone to collect an item, etc. In these instances, the individual may be time conflicted or activity conflicted to seek the service they need. At present, there are no systems and/or service providers offering the ability for an individual to simply and automatically seek for competing bids such that they can balance these conflicts.

At the same time, a provider of a service, for example, may be able to provide the required service immediately or within a short timeframe but is unaware of the requirement unless the individual contacts them. Hence, the focus historically in attention grabbing advertisements in printed communications such as the local newspaper, magazines, national newspaper, and telephone book (i.e. Yellow Pages™) and similarly within the Internet with keywords etc. as individuals search to fulfill their need.

Accordingly, it would be beneficial for service providers and individuals to be able to access an online portal/software application allowing for the distribution of requirements from individuals and responses from service providers. However, in contrast to prior art solutions, embodiments of the invention are geared to time sensitive and immediate requirements rather than traditional procurement/order fulfillment cycles. Embodiments of the invention are intended to provide widespread dissemination of requirements and consolidation of responses to the requester.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to service provisioning/requests and more particularly to service provisioning/requests with immediate/short-term requirements.

In accordance with an embodiment of the invention, there is provided a method comprising providing a first user interface upon an electronic device comprising at least a microprocessor allowing a user to enter a time-sensitive requirement and providing a second user interface allowing the user to establish a plurality of service providers to whom the time-sensitive requirement should be communicated. The method further comprising transmitting data relating to the time-sensitive requirement and the plurality of service providers to a computer server via a network, automatically with the computer server distributing to the plurality of service providers a first message relating to the time-sensitive requirement using at least one communications protocol of a plurality of available communications protocols, and receiving with the computer server receiving at least one of a first response relating to a service provider's ability to fulfill the time-sensitive requirement and a second response relating to a service provider declining to address the time-sensitive requirement.

In accordance with an embodiment of the invention, there is provided a method comprising providing upon a computer server accessible via network a service to a user through an electronic device connected to the network, the service allowing a user to contact a plurality of service providers based upon their establishment of a requirement where each service provider is contacted according to the contact means identified by the service provider within a service provider directory stored upon the computer server, wherein the user specifies only the requirement and any applicable limits but does not format or generate any of the messages sent to the group of service providers by the service.

In accordance with an embodiment of the invention, there is provided a method of providing to a user responses from a group of service providers based upon a user's previously established requirement where each service provider has been contacted according to the contact means identified by the service provider within a service provider directory where the user specifies the requirement and any applicable limits but does not format or generate any of the messages sent to the group of service providers and the responses are provided in a single user interface irrespective of the means each service provider contacts the user.

In accordance with an embodiment of the invention, there is provided a method of allowing a user to select a service provider to perform a time-sensitive service request comprising providing to the user upon an electronic device a display comprising at least a map, the map comprising at least indicators relating to a location specified by the user at which the time-sensitive service request is to be provided and current geographic locations of service providing assets of each service provider of a plurality of service providers able to complete the time-sensitive requirement within a time limit established by the user relating to the time-sensitive service request.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a prior art service provider search means based upon a search engine;

FIG. 2A depicts online service provider contact means such as business bureaus, online Yellow Pages™, flyers, and physical advertisements;

FIG. 2B depicts an online business-to-business auction solution according to the prior art;

FIG. 3 depicts a network environment within which embodiments of the invention may be employed;

FIG. 4 depicts a wireless portable electronic device supporting communications to a network such as depicted in FIG. 1 and as supporting embodiments of the invention;

FIG. 5 depicts an exemplary process flow according to an embodiment of the invention;

FIG. 6 depicts an exemplary process flow according to an embodiment of the invention;

FIG. 7 depicts smartphone screen mock-ups for an Automatic Service Provider APplication (ASPAP) according to an embodiment of the invention;

FIG. 8 depicts smartphone screen mock-ups for an ASPAP according to an embodiment of the invention;

FIG. 9 depicts smartphone screen mock-ups for an ASPAP according to an embodiment of the invention;

FIG. 10 depicts a smartphone screen mock-up for an ASPAP according to an embodiment of the invention;

FIG. 11 depicts an exemplary process flow for service call placement, fulfillment and dispute resolution according to an embodiment of the invention;

FIG. 12 depicts an exemplary process flow for service call placement based upon service level and service roll-over according to an embodiment of the invention; and

FIGS. 13A and 13B depict exemplary smartphone screen mockups for map interfaces presented to a user of an ASPAP according to an embodiment of the invention.

### DETAILED DESCRIPTION

The present invention is directed to service provisioning/requests and more particularly to service provisioning/requests with immediate/short-term requirements.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader. A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “social network” or “social networking service” as used herein may refer to, but is not limited to, a platform to build social networks or social relations among people who may, for example, share interests, activities, backgrounds, or real-life connections. This includes, but is not limited to, social networks such as U.S. based services such as Facebook, Google+, Tumblr and Twitter; as well as Nexopia, Badoo, Bebo, VKontakte, Delphi, Hi5, Hyves, iWiW, Nasza-Klasa, Soup, Glocals, Skyrock, The Sphere, StudiVZ, Tagged, Tuenti, XING, Orkut, Mxit, Cyworld, Mixi, renren, weibo and Wretch.

“Social media” or “social media services” as used herein may refer to, but is not limited to, a means of interaction among people in which they create, share, and/or exchange information and ideas in virtual communities and networks. This includes, but is not limited to, social media services relating to magazines, Internet forums, weblogs, social blogs, microblogging, wikis, social networks, podcasts, photographs or pictures, video, rating and social bookmarking as well as those exploiting blogging, picture-sharing, video logs, wall-posting, music-sharing, crowdsourcing and voice over IP, to name a few. Social media services may be classified, for example, as collaborative projects (for example, Wikipedia); blogs and microblogs (for example, Twitter™); content communities (for example, YouTube and DailyMotion); social networking sites (for example, Facebook™); virtual game-worlds (e.g., World of Warcraft™); and virtual social worlds (e.g. Second Life™).

An “Automatic Service Provider APplication” (ASPAP) as used herein may refer to, but is not limited to, a software system and/or software application which provides users with a centralized contact management system relating to their placing requirements for immediate and/or short timescale services and provides service providers with immediate and/or short timescale requirements from users.

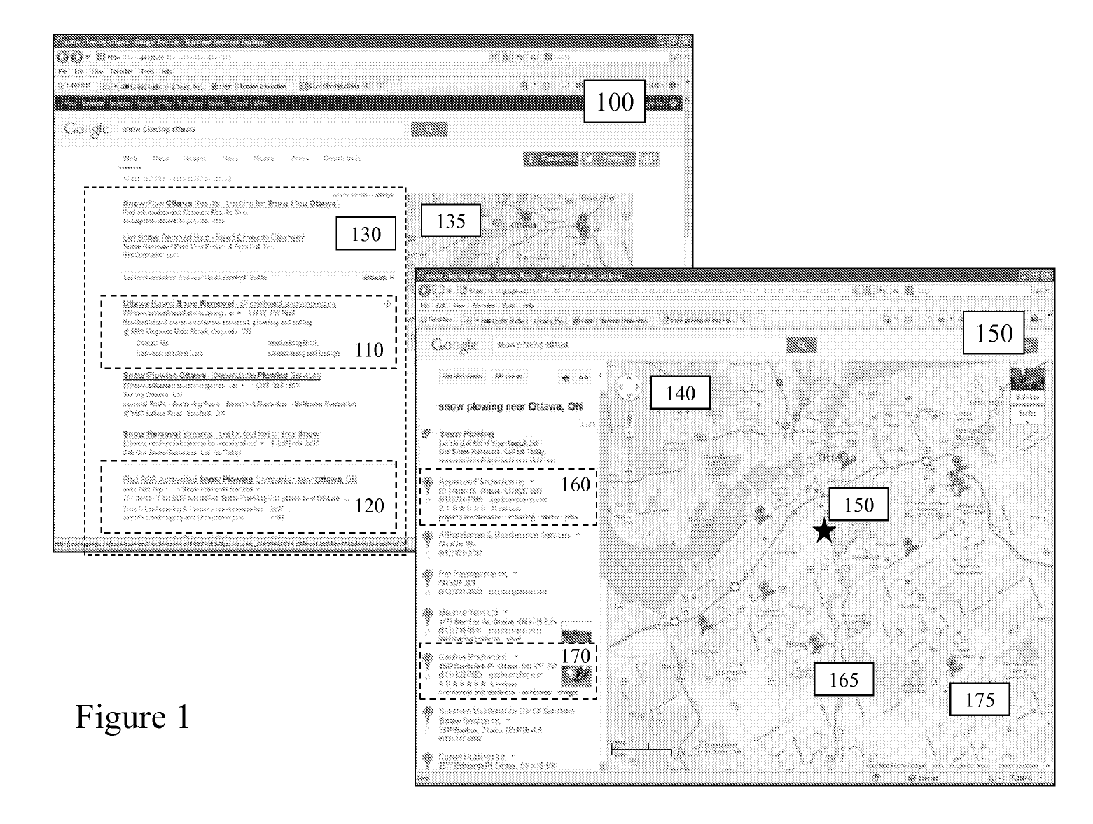

Now referring to FIG. 1, there is depicted a prior art service provider search means based upon a search engine, in this instance Google™. As depicted in first browser image 100, the user has selected to search “snow plowing Ottawa” resulting in search results 130 including first and second results 110 and 120 and results map 135. When the user selects results map 135 they are presented with second browser image 150 which provides the map 140 and map location pins “A” 165 and “E” 175 relating to identified providers “A” 160 and “E” 170 identified in the left column which have keywords matching those within the search terms entered by the user. Accordingly, in order to obtain a service from any of these the user must call, email or complete an online questionnaire and proceed from that point onwards.

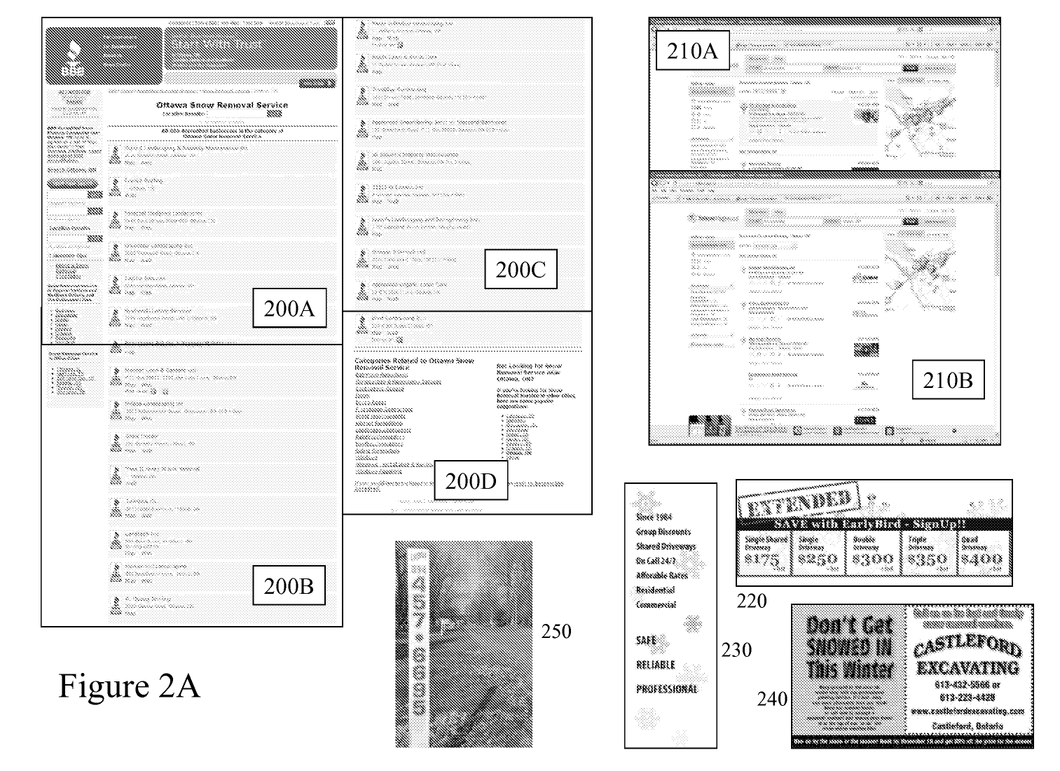

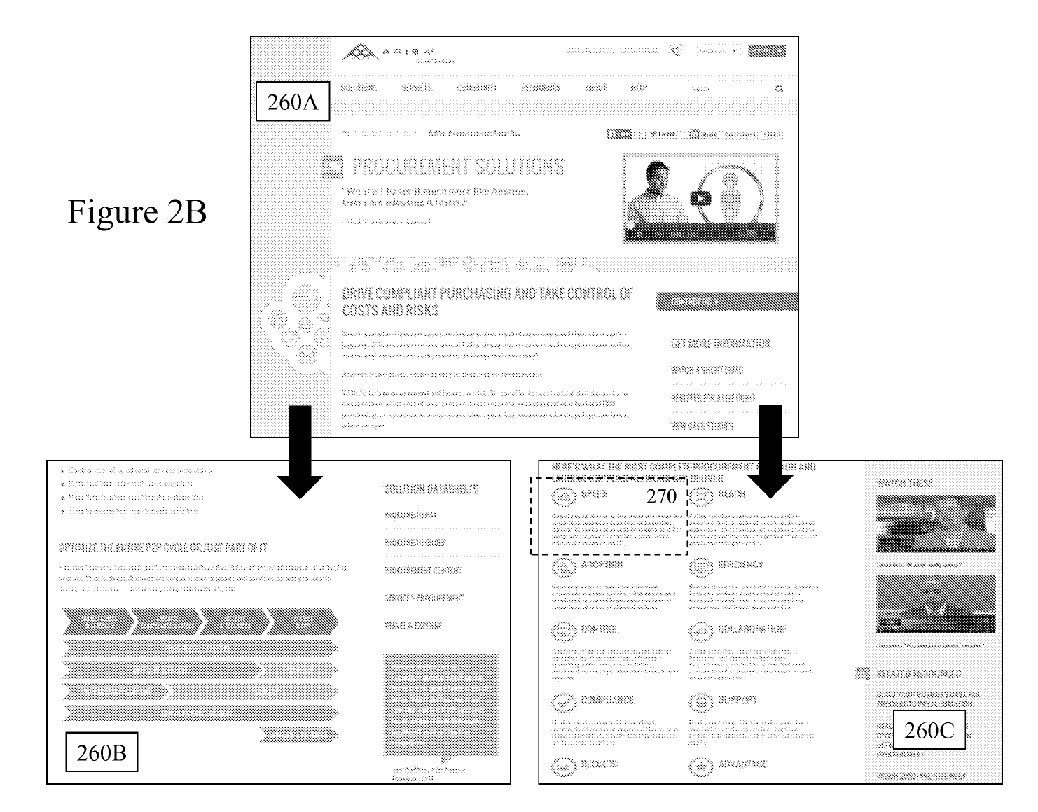

Similarly, if the user has selected second result 120 in first browser image 100 in FIG. 1, representing the Better Business Bureau in Ottawa then they are taken to another website which presents a list of providers as depicted in first to fourth images 200A to 200D respectively in FIG. 2A. In this instance the user now has increased confidence in the quality/reputation of the service providers but still must call, email or complete an online questionnaire with those they wish to have information from and proceed from that point onwards. Accordingly, as with using the search engine approach the user may contact a large number of service providers and not get a response that meets their requirements as the time for reply etc. from the service providers may be longer than the time period within which the user seeks to have a service provided. The same issues arise if the user accesses other third party consolidators such as Yellow Pages™ as indicated in fifth and sixth images 210A and 210B respectively. Other sources of service providers may include flyers distributed to the user's residence or collected from other locations, examples of which are depicted by first to third flyers 220 to 240 respectively, and other advertising such as snow lane marker 250 for example.

Now referring to FIG. 2B, there is are depicted first to third webpages 260A to 260C for Ariba™ which is an online business-to-business (B2B) auction service provider that hosts auction wherein a first business places a requirement and multiple businesses provide their bids for the business. Ariba™ hosts an example of a reverse auction wherein the roles of “buyer” and “seller” are reversed. In an ordinary auction (also known as a forward auction), buyers compete to obtain a good or service by offering increasingly higher prices for the item offered by the seller and accordingly, prices will typically decrease as the sellers undercut each other. However, as indicated within their own publicity materials in third webpage 260C in speed highlight 270 they state that the service provides “time-to-value within weeks” and “full program payback in under a year.” As the B2B auction service is geared primarily to longer term strategic purchasing, it is not appropriate for immediate one off service provisioning where in fact lowest price might not be the key determinant as other factors may be more important to the user such as time to service delivery for example.

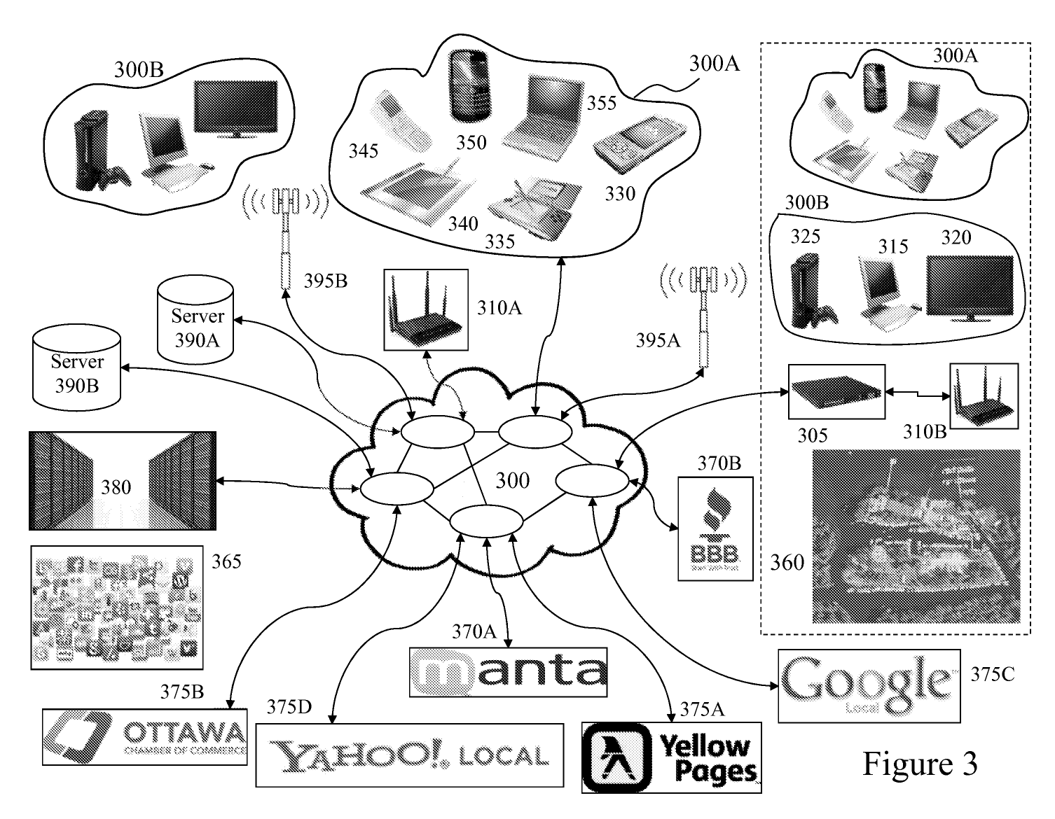

Referring to FIG. 3, there is depicted a network environment 300 within which embodiments of the invention may be employed supporting SOCMES and/or SOCNETS. As shown, first and second user groups 300A and 300B respectively interface to a telecommunications network 300. Within the representative telecommunication architecture, a remote central exchange 380 communicates with the remainder of a telecommunication service providers network via the network 300 which may include for example long-haul OC-48/OC-192 backbone elements, an OC-48 wide area network (WAN), a Passive Optical Network, and a Wireless Link. The central exchange 380 is connected via the network 300 to local, regional, and international exchanges (not shown for clarity) and therein through network 300 to first and second cellular APs 395A and 395B respectively which provide Wi-Fi cells for first and second user groups 300A and 300B respectively. Also connected to the network 300 are first and second Wi-Fi nodes 310A and 310B, the latter of which being coupled to network 300 via router 305. Second Wi-Fi node 310B is associated with Enterprise 360 within which are other first and second user groups 300A and 300B. Second user group 300B may also be connected to the network 300 via wired interfaces including, but not limited to, DSL, Dial-Up, DOCSIS, Ethernet, G.hn, ISDN, MoCA, PON, and Power line communication (PLC) which may or may not be routed through a router such as router 305.

Within the cell associated with first AP 310A the first group of users 300A may employ a variety of PEDs including for example, laptop computer 355, portable gaming console 335, tablet computer 340, smartphone 350, cellular telephone 345 as well as portable multimedia player 330. Within the cell associated with second AP 310B are the second group of users 300B which may employ a variety of FEDs including for example gaming console 325, personal computer 315 and wireless/Internet enabled television 320 as well as cable modem 305. First and second APs 395A and 395B respectively provide, for example, cellular GSM (Global System for Mobile Communications) telephony services as well as 3G and 4G evolved services with enhanced data transport support. Second cellular AP 395B provides coverage in the exemplary embodiment to first and second user groups 300A and 300B. Alternatively, the first and second user groups 300A and 300B may be geographically disparate and access the network 300 through multiple APs, not shown for clarity, distributed geographically by the network operator or operators. First cellular AP 395A as shown provides coverage to first user group 300A and environment 370, which comprises second user group 300B as well as first user group 300A. Accordingly, the first and second user groups 300A and 300B may according to their particular communications interfaces communicate to the network 300 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-2000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 300A may form associations either through standards such as IEEE 802.15 and Bluetooth as well in an ad-hoc manner.

Also connected to the network 300 are SOCNETS 365, first and second business reference services 370B and 370A respectively, depicted as Better Business Bureau (BBB) and Manta respectively, first and second business directories 375A and 375B respectively, depicted as Yellow Pages™ and Ottawa Chamber of Commerce respectively, and first and second search engines 375C and 375D respectively, depicted as Google™ and Yahoo™ respectively, as well as first and second servers 390A and 390B which together with others, not shown for clarity, may host according to embodiments of the inventions multiple services associated with a provider of an ASPAP SOCNETSS and/or ASPAP SOMES; a provider of a SOCNETS and/or SOMES exploiting or supporting ASPAP features; a provider of a SOCNETS and/or SOMES not exploiting or supporting ASPAP features; a provider of services to PEDS and/or FEDS; a provider of one or more aspects of wired and/or wireless communications; an Enterprise 360 exploiting ASPAP features, e.g. Royal Canadian Yacht Club in Toronto, Ontario; license databases; customer databases; websites; and software applications for download to or access by FEDs and/or PEDs exploiting and/or hosting ASPAP features. First and second primary content servers 390A and 390B may also host for example other Internet services such as a search engine, financial services, third party applications and other Internet based services.

Accordingly, a user with a PED and/or FED may, for example, access one of the first or second primary content servers 390A and 390B respectively to download an application which provides ASPAP features according to embodiments of the invention. Subsequently, during use of the PED the user may enter locations such as typified by Enterprise 360 coming into wireless contact with first and second user groups 300A and 300B as well as first and second APs 310A and 310B respectively and first and second cellular APs 395A and 395B respectively. Accordingly, the user may exploit their own normal SOCNETS and/or SOMES or they may access a SOCNETS and/or SOMES associated with the Enterprise 360. As discussed below, in respect of embodiments of the invention, the user may therefore form new contacts within their SOCNETS and/or SOMES or the SOCNETS and/or SOMES associated with the Enterprise 360 wherein these new contacts may be associated with ASPAP features generated by the user.

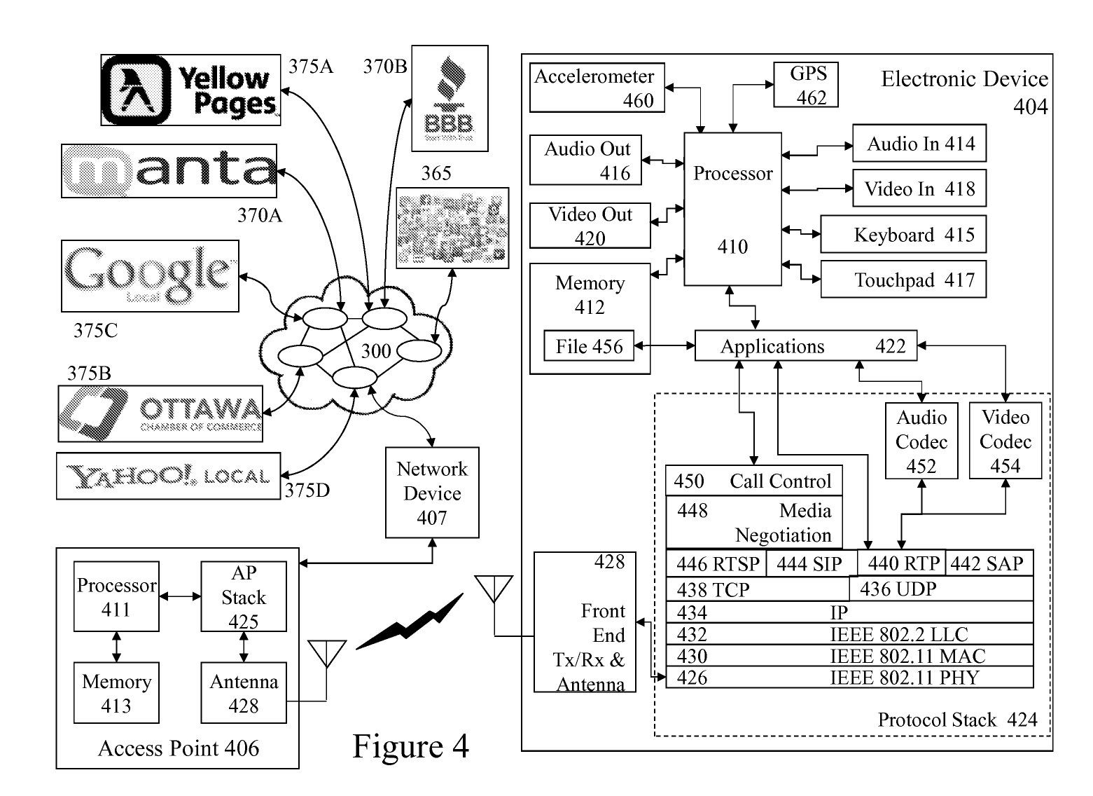

Now referring to FIG. 4, there is depicted an electronic device 404 and network access point 407 supporting contextual based UIs according to embodiments of the invention. Electronic device 404 may for example be a portable electronic device or a fixed electronic device and may include additional elements above and beyond those described and depicted. Also depicted within the electronic device 404 is the protocol architecture as part of a simplified functional diagram of a system 400 that includes an electronic device 404, such as a smartphone 355, an access point (AP) 406, such as first AP 310, and one or more network devices 407, such as communication servers, streaming media servers, and routers for example such as first and second servers 390A and 390B respectively. Network devices 407 may be coupled to AP 406 via any combination of networks, wired, wireless and/or optical communication links such as network 300 discussed supra in respect of FIG. 3. From network devices 407 and network 300 allow the user of electronic device 404 to access one or more resources including, but not limited to. Also connected to the network 300 are SOCNETS 365, first and second business reference services 370B and 370A respectively, depicted as Better Business Bureau (BBB) and Manta respectively, first and second business directories 375A and 375B respectively, depicted as Yellow Pages™ and Ottawa Chamber of Commerce respectively, and first and second search engines 375C and 375D respectively, depicted as Google™ and Yahoo™ respectively, as well as first and second servers 390A and 390B.

The electronic device 404 includes one or more processors 410 and a memory 412 coupled to processor(s) 410. AP 406 also includes one or more processors 411 and a memory 413 coupled to processor(s) 410. A non-exhaustive list of examples for any of processors 410 and 411 includes a central processing unit (CPU), a digital signal processor (DSP), a reduced instruction set computer (RISC), a complex instruction set computer (CISC) and the like. Furthermore, any of processors 410 and 411 may be part of application specific integrated circuits (ASICs) or may be a part of application specific standard products (ASSPs). A non-exhaustive list of examples for memories 412 and 413 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 404 may include an audio input element 414, for example a microphone, and an audio output element 416, for example, a speaker, coupled to any of processors 410. Electronic device 404 may include a video input element 418, for example, a video camera, and a video output element 420, for example an LCD display, coupled to any of processors 410. Electronic device 404 also includes a keyboard 415 and touchpad 417 which may for example be a physical keyboard and touchpad allowing the user to enter content or select functions within one of more applications 422. Alternatively, the keyboard 415 and touchpad 417 may be predetermined regions of a touch sensitive element forming part of the display within the electronic device 404. The one or more applications 422 that are typically stored in memory 412 and are executable by any combination of processors 410. Electronic device 404 also includes accelerometer 460 providing three-dimensional motion input to the process 410 and GPS 462 which provides geographical location information to processor 410.

Electronic device 404 includes a protocol stack 424 and AP 406 includes a communication stack 425. Within system 400 protocol stack 424 is shown as IEEE 802.11 protocol stack but alternatively may exploit other protocol stacks such as an Internet Engineering Task Force (IETF) multimedia protocol stack for example. Likewise AP stack 425 exploits a protocol stack but is not expanded for clarity. Elements of protocol stack 424 and AP stack 425 may be implemented in any combination of software, firmware and/or hardware. Protocol stack 424 includes an IEEE 802.11-compatible PHY module 426 that is coupled to one or more Front-End Tx/Rx & Antenna 428, an IEEE 802.11-compatible MAC module 430 coupled to an IEEE 802.2-compatible LLC module 432. Protocol stack 424 includes a network layer IP module 434, a transport layer User Datagram Protocol (UDP) module 436 and a transport layer Transmission Control Protocol (TCP) module 438.

Protocol stack 424 also includes a session layer Real Time Transport Protocol (RTP) module 440, a Session Announcement Protocol (SAP) module 442, a Session Initiation Protocol (SIP) module 444 and a Real Time Streaming Protocol (RTSP) module 446. Protocol stack 424 includes a presentation layer media negotiation module 448, a call control module 450, one or more audio codecs 452 and one or more video codecs 454. Applications 422 may be able to create maintain and/or terminate communication sessions with any of devices 407 by way of AP 406. Typically, applications 422 may activate any of the SAP, SIP, RTSP, media negotiation and call control modules for that purpose. Typically, information may propagate from the SAP, SIP, RTSP, media negotiation and call control modules to PHY module 426 through TCP module 438, IP module 434, LLC module 432 and MAC module 430.

It would be apparent to one skilled in the art that elements of the electronic device 404 may also be implemented within the AP 406 including but not limited to one or more elements of the protocol stack 424, including for example an IEEE 802.11-compatible PHY module, an IEEE 802.11-compatible MAC module, and an IEEE 802.2-compatible LLC module 432. The AP 406 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 404 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-2000, DSL, Dial-Up, DOCSIS, Ethernet, G.hn, ISDN, MoCA, PON, and Power line communication (PLC).

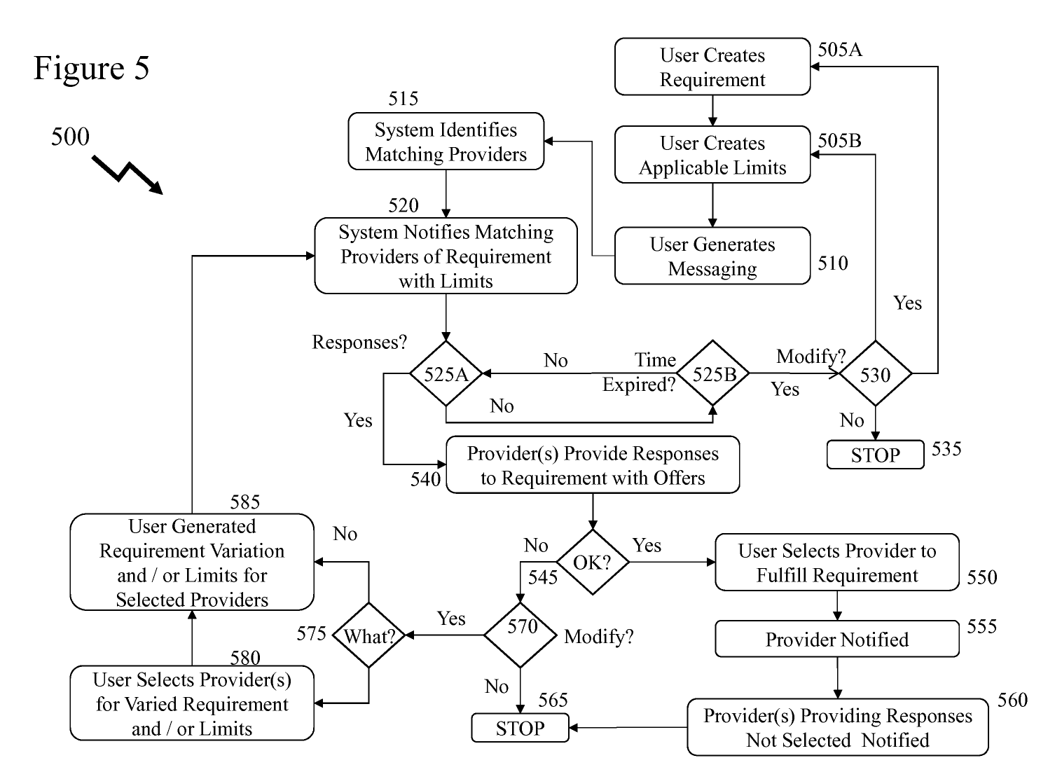

Now referring to FIG. 5, there is depicted an exemplary process flow 500 according to an embodiment of the invention. The process begins with step 505A wherein a user creates a requirement, e.g. new drive plowed, need burst pipe fixed, someone to walk dog, and need taxi to airport. This may be selected from a drop-down menu sequence of types of service and sub-services or it may be a free-form entry such as the user may employ on a search engine. Subsequently, in step 505B they create applicable limits, e.g. by 12 pm, immediately, by 10 am, between 3 pm and 5 pm, and next hour. Other limits may include cost limitations, e.g. maximum $100, or geographical requirements, e.g. Ottawa, Belleville, Greater Toronto, etc. It would be evident that an ASPAP may provide a series of predetermined fields for the user to populate relating to common limits or it may provide a free-form entry such as the user may employ on a search engine. In order that the ASPAP on behalf of the user can access a large number of matching providers with disparate communication routes the ASPAP prompts the user in step 515 to enter a message. This message may, for example, be a short audio message allowing the ASPAP to engage providers with the user's own audio message as whilst multiple electronic messages can be easily sent telephone contact is more problematic and any providers may simply skip or delete the message early into it based upon hearing an automated voice message.

Based upon the entered data for the requirement and limits the ASPAP software system and/or software application (SSSA) performs a search in step 515 to identify providers matching the requirement, e.g. snow plowing, dog walking, taxi, plumber, etc. Such service providers may have registered with the ASPAP providing a list of services they provide together with any geographical restrictions, time restrictions etc., which may be employed in the ASPAP SSSA matching process together with one or more contact means, e.g. email address(es), office telephone number(s), service engineer cellphone number(s), facsimile, Facebook page, Twitter, etc. Alternatively, the ASPAP SSSA may extract data from one or more external resources including, but not limited to, business reference services (e.g. first and second business reference services 370B and 370A respectively, depicted as Better Business Bureau (BBB) and Manta respectively), business directories (e.g. first and second business directories 375A and 375B respectively, depicted as Yellow Pages™ and Ottawa Chamber of Commerce respectively), search engines (e.g. first and second search engines 375C and 375D respectively, depicted as Google™ and Yahoo™ respectively), and databases (e.g. those stored on external and/or remote services such first and second servers 390A and 390B for example).

In step 520 the ASPAP SSSA notifies matching providers of the requirement with limits relating to the user. In step 525A the process determines whether responses have been received from the matching providers or not and proceeds to either step 540 upon a positive determination or step 525B upon a negative determination. In step 525B the process checks to determine whether a time limit associated with the requirement has expired, e.g. “Need a taxi in next 10 minutes” or “Need dog walker between 3 pm and 5 pm but must know by 2 pm.” Based upon this the process proceeds to either step 530 upon a positive determination or returns to step 525A upon a negative determination. In step 525B the user is provided with the option as to whether they wish to modify the requirement and/or limits or not such that the process proceeds either back to step 505A upon a positive determination to change the requirement, back to step 505B upon a positive determination to change only the limits, or step 535 upon a negative determination.

Where in step 525A a positive determination was made and the process proceeds to step 540 the user is provided with the responses from the providers to their requirement, referred to as offers within the context of this process. As such offers may be received in multiple formats, e.g. voicemail, text, email, SOCNET posting the ASPAP application merges these to a single coherent offer presentation to the user. Then in step 545 the user determines whether any of the offers match their requirement and the process proceeds to either step 550 upon a positive determination or step 570 upon a negative determination. With the positive determination the user selects the provider to fulfill the requirement in step 550 wherein the process proceeds to notify the selected provider in step 555 and the providers who made offers but were not selected providers are notified in step 560 whereupon the process proceeds to step 565 and stops.

With a negative determination in step 545 the process proceeds to step 570 wherein the user determines whether to modify the requirement and/or limits. A negative determination may arise as whilst offers are made their limits do not exactly match the limits set by the user or by the time the offers are made the requirement and/or limits have changed. Accordingly based upon the determination in step 570 the process proceeds to either step 575 upon a positive determination or step 565 and stops upon a negative determination. In step 575 the user determines whether to make variations to a subset of the providers providing responses, wherein the process proceeds to step 580 such that they can select those providers to receive the modified response or whether they are going to vary the requirement and/or limits for all responding providers in which case the process proceeds to step 585 wherein the new requirement and/or limits are generated. This step is also performed where the user selects a subset of providers as from step 580 the process proceeds to step 585. From step 585 the process proceeds back to step 520 and the providers are notified of the revised requirement and/or limits. Optionally, after step 585 another step is performed similar to step 510 wherein the user generates a replacement message, e.g. replacement audio message.

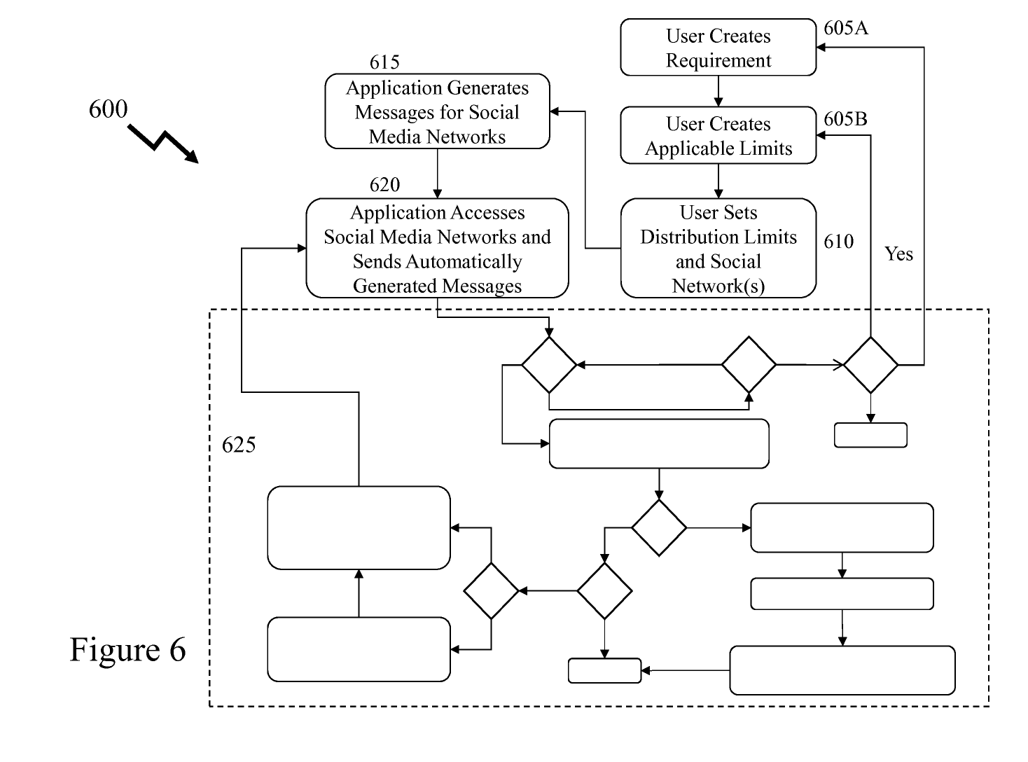

Now referring to FIG. 6, there is depicted an exemplary process flow 600 according to an embodiment of the invention wherein a user's requirement is distributed through their social networks as opposed through email, telephone, etc. as described above in respect of FIG. 5 and process flow 500. Accordingly, the process begins with step 605A wherein a user creates a requirement, e.g. new drive plowed, need burst pipe fixed, someone to walk dog, and need taxi to airport. This may be selected from a drop-down menu sequence of types of service and sub-services or it may be a free-form entry such as the user may employ on a search engine. Subsequently, in step 605B they create applicable limits, e.g. by 12 pm, immediately, by 10 am, between 3 pm and 5 pm, and next hour. Other limits may include cost limitations, e.g. maximum $100, or geographical requirements, e.g. Ottawa, Belleville, Greater Toronto, etc. It would be evident that an ASPAP may provide a series of predetermined fields for the user to populate relating to common limits or it may provide a free-form entry such as the user may employ on a search engine. In order that the ASPAP on behalf of the user only distributes the message according to user defined conditions then the process in step 610 provides the user with the ability to define distribution limits. Such limits, may for example, be family, friends, all contacts, friends-of-friends, contacts with 2 degrees of separation (where a degree of separation is link between two individuals), etc. As the user may also be part of multiple SOCNETs, this step also allows the user to restrict which SOCNETs are employed for the distribution of the requirement. Since the multiple SOCNETs have disparate communication requirements then in step 615 the ASPAP generates messages according to predefined templates and/or rules. For example, a Facebook™ posting may be structured from a template such as shown below in (1) whilst a Twitter™ message may be structured from a template as shown below in (2). {A}, {B}, {C}, {D} are data captured from the user's requirement and/or limits whilst elements within < > are conditionally added depending upon whether data relating to them forms part of the user's requirement and/or limits and elements.

$$\begin{matrix}\vert \begin{matrix}Hi \text{,} \{ E \} \text{,} \{ A \} hasneedof \{ B \} urgently \text{.} CanyouhelpmepleaseHowever \text{,} itmustbe \\ 〈 lessthan\$ \{ C \} 〉 〈 andavailable 〉 〈 between \{ D \} 〉 〈 assoonaspossible 〉 〈 before \{ D \} 〉\end{matrix} \vert & ( 1 ) \\ \vert URGENT Need \{ B \} - max \$ \{ C \} - between \{ D \} \vert & ( 2 )\end{matrix}$$

In step 620 the ASPAP SSSA notifies contacts matching the SOCNET(s) and/or distribution limits established by the user in step 610 and transmits the messages generated in step 615. From step 620 the process proceeds to sequence block 620 which essentially comprises steps 525A to 585 as described supra in respect of FIG. 5 but wherein providers are now contacts. However, as contacts within SOCNETs may be individuals as well as enterprises, contractors, etc. then responses may be received from multiple sources.

Accordingly, a user exploiting an ASPAP may contact a wide number of contacts/service providers in order to source a service that is required immediately or near-term. Similarly service providers may obtain requests which they can complete within the limits set by the user but may not have been contacted by the user from their searches through prior art resources such as search engines, business directories etc.

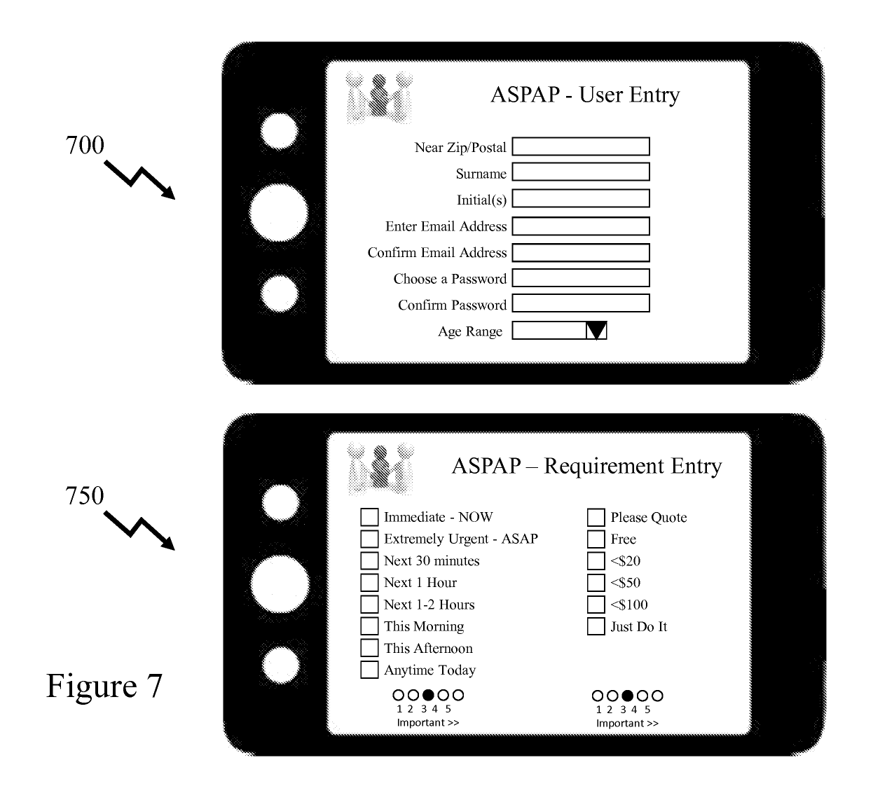

Now referring to FIG. 7, there are depicted first and second smartphone screen mock-ups 700 and 750 for an ASPAP according to an embodiment of the invention. First smartphone screen mock-up 700 depicts a user entry screen wherein a user provides basic information to either register with an ASPAP or generate a requirement within an ASPAP without registering. Second smartphone screen mock-up 750 depicts a subsequent user entry screen relating to the requirement in terms of defining limits relating to time and cost. It would be evident to one skilled in the art that others may be provided to a user or an initial list of options may be presented triggering a series of subsequent screens to the user.

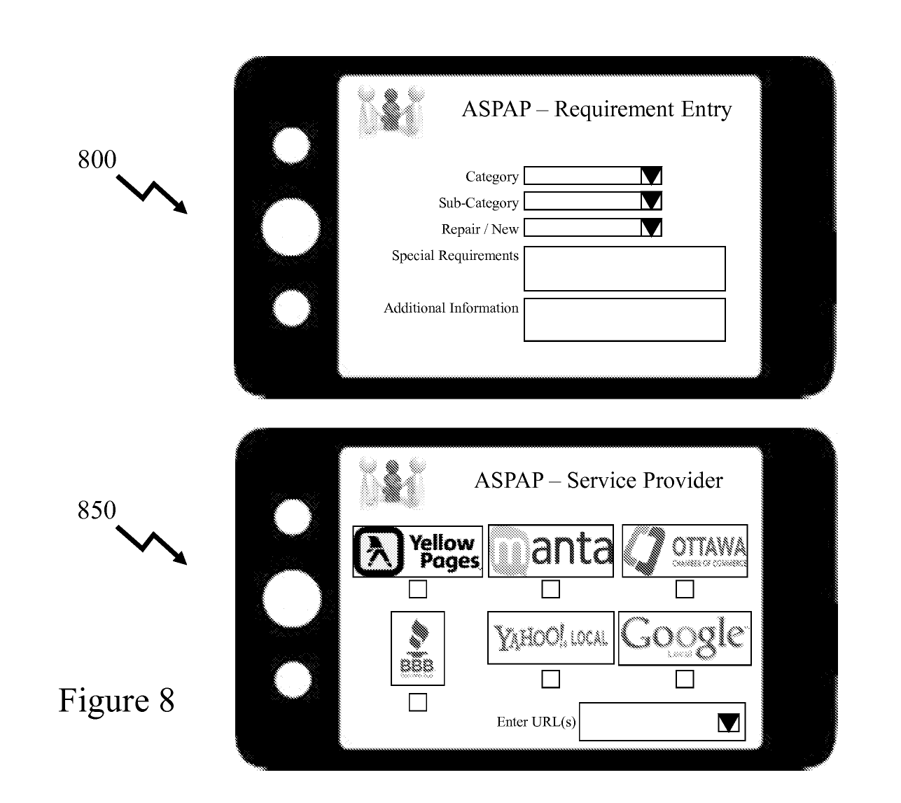

Referring to FIG. 8, there are depicted first and second smartphone screen mock-ups 800 and 850 for an ASPAP according to an embodiment of the invention. First smartphone screen mock-up 800 depicts a requirement entry screen wherein the user selects the category of service, e.g. heating, ventilation, and air conditioning (HVAC), a sub-service if applicable, e.g. heating—furnace, and then can enter through free format text fields any additional information and special requirements. Second smartphone screen mock-up 850 depicts a user entry screen relating to the selection of business register providers and other resources to be searched for service providers. Additionally, the user may enter a Uniform Resource Locator (URL) or URLs for other directories, resources, or specific service providers. It would be evident to one skilled in the art that within other embodiments of the invention the ASPAP may maintain a registry of service providers which is accessed solely or as an initial resource prior to other external resources.

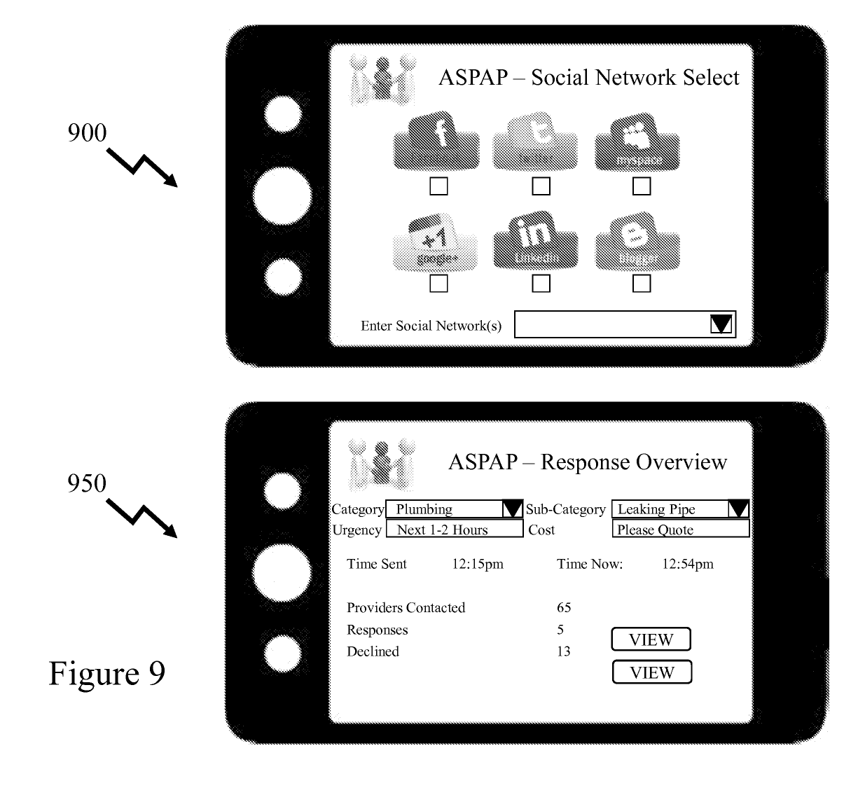

Now referring to FIG. 9, there are depicted first and second smartphone screen mock-ups 900 and 950 for an ASPAP according to an embodiment of the invention. First smartphone screen mock-up 900 depicts a user entry screen relating to the selection of SOCNETS and/or SOMES and other resources to be searched for contacts. Additionally, the user may enter an identity of a social network or contact database, e.g. their email contact list. It would be evident to one skilled in the art that within other embodiments of the invention the ASPAP may maintain a registry of contacts which is accessed solely or as an initial resource prior to other external resources. Second smartphone screen mock-up 850 depicts a response overview presented to a user indicating their request in key detail form, the time the request was sent, the current time, the number of providers contacted, the number of responses and the number of decline messages.

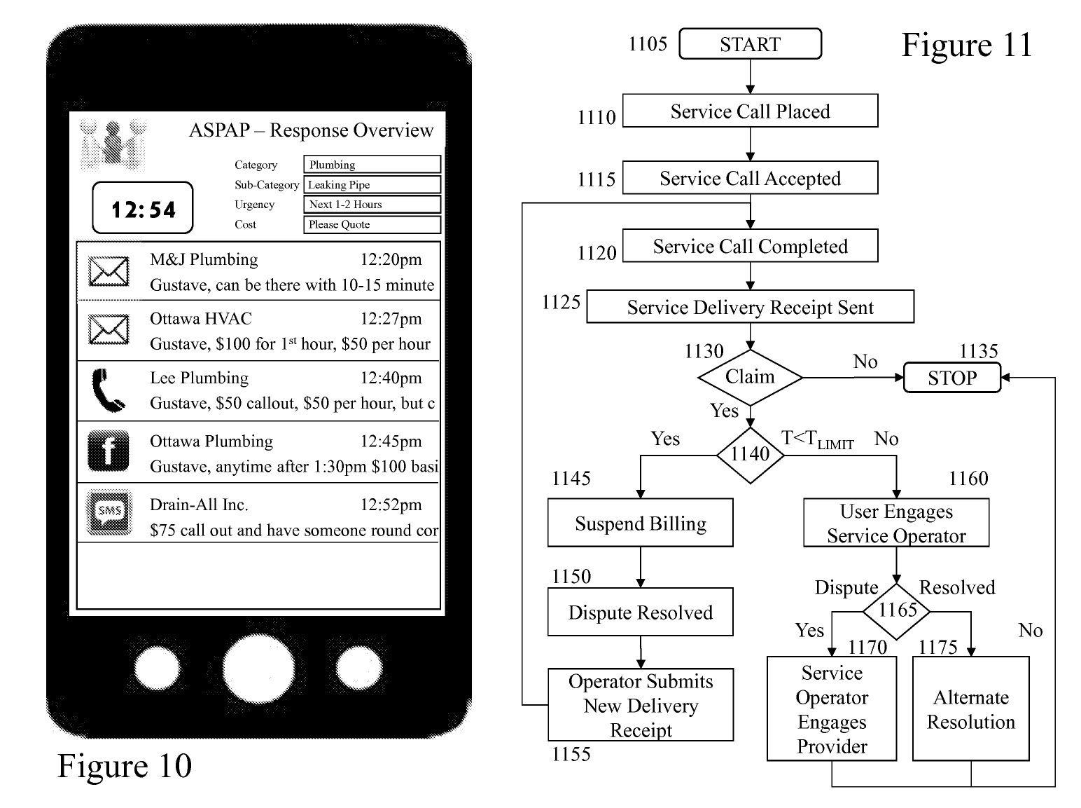

FIG. 10 depicts a smartphone screen mock-up for an ASPAP according to an embodiment of the invention depicting a message screen of the responses received indicating their request in key detail form, the current time, and a list of the responses received indicating for each the format of the received response, e.g. email, voicemail, text, social network etc. For each message there is indicated the name of the service provider, the time the message was received and the beginning of the message. It would be evident to one skill in the art that the user may select one of the responses and this may open in a manner known to those in the art as current smartphone email and text programs for example. Optionally, the user may respond within the ASPAP as they would within a text or email application to clarify the service provider's response. An opened message may include an accept icon that then notifies the ASPAP that the user has selected the service provider thereby allowing for an acceptance message to be sent to that service provider and messages to non-selected service providers who responded indicating the user has made a decision.

It would be evident that an ASPAP and/or ASPAP SSSA according to embodiments of the invention may exploit additional features including, but not limited to:

Provider Referrals—wherein a service provider contacted may forward the message to another service provider. Optionally, this may be via a link within an email for example wherein the linked webpage allows the service provider to add the new details and have the message sent but the ASPAP SSSA when presenting the provider response messages to the user may flag one from the new service provider as being a referral.

Provider Ratings—wherein users upon completion of a requirement may rate the service provider such that when another user receives provider messages these may for example include additional information such as a rating score or be sorted by rating.

No Show Ratings—wherein users upon engaging a provider against a requirement may rate the service provider if they do not execute any aspect of the requirement such that even though a service provider receive high ratings for jobs they perform they have also an indication that not reliable, for example.

Auto GPS—wherein for predetermined or user selected requirements the message provided to the service providers includes a GPS location so that they may easily factor travel time into their ability to meet the requirement or into their response, e.g. a provider may be free to provide a courier service required in 15 minutes but currently is 20-25 minutes away.

Zip/Postal—wherein initial service provider contacts are provided via zip code/postal address/nearest intersection so that the service provider has sufficient detail to know approximately where but not sufficient to locate the user immediately unless the user provides this or potentially the exact location data is automatically provided when the user accepts an offer from a specific service provider.

Guarantee—DownPayment—wherein the user provides a guarantee/initial payment to the selected provider so that they know the user is genuine. This may be handled through one or more financial systems such as PayPal™, credit card™, etc.

Decline—wherein a service provider may respond with a decline to the user. Such a decline feature provides a service provider with a means of acknowledging the user's requirement but indicating an inability to meet it within the limits set. According, where a user adjusts the limits such as described supra in respect of FIGS. 5 and 6 such service providers may be included within a subsequent group contacted as with modified limits they may be able to meet the user's requirement.

The description supra in respect of FIGS. 1 through 10 for an ASPAP and/or ASPAP SSSA according to embodiments of the invention supports a range of services with immediacy aspects for users. By way of an example, the following description describes aspects of an ASPAP and/or ASPAP SSSA according to embodiments of the invention as they relate to the provisioning of snow plow (snow plough) services by service providers (Independent Operators) for users (customers). For ease of reference the provisioning of snow plow services is referred to under the banner of “ePlow™” representing an ASPAP and/or ASPAP SSSA established according to embodiments of the invention. Accordingly, embodiments of the invention support the establishment of, but not limited to, the following services:

“On Demand”
Snow is removed as needed, during or just after a snowfall, and requirements are established within timescales of less than an hour to hours.
Customers and operators have price certainty according to simple specifications of job.

“Near Term Contracts”
Snow is removed as required by the customer but flexibility, e.g. am on way to work and want it done before get home, such that requirements are established within timescales of few hours to a few days.

“Short Term Contracts”
Independent operators may bid on-line with other Independent Operators for contracts posted by customers of a pre-specified (a) number of removals and/or (b) time (i.e. 1 to several weeks).
Suitable for vacationers, work travelers, absent spouses etc.

“Seasonal Contracts”
Independent Operators can bid on-line with other Independent Operators for contracts posted by customers of a pre-specified (a) number of removals and/or (b) time (i.e. a season).
Ideal for customers that consider a seasonal contract hassle-free.

Within the description, service providers, herein referred to as Independent Operators, have aspects of their interactions with the users within embodiments of the invention are controlled through their “Independent Operator On-Line Profiles.” These profiles provide for:

Transparency of Profile. Operators must submit an on-line “Independent Operator Profile” to ePlow™ showcasing the following information to consumers (office location, incorporation date/years of service, geographical customer base—counties/municipalities in which licensed, proof of licensing and insurance, snow removal equipment portfolio, pictures of equipment & operator).

Transparency of Capabilities. Operators must confirm and profile their ability to remove snow of pre-defined depths, i.e. <1 ft, <2 ft, <3+ ft, or >3 ft, address slopes of various grades, i.e. tire chains.

Transparency of Performance and Dependability. Operators' customer satisfaction and performance ratings are visible to potential customers and may be considered before entering into an agreement with an independent operator. Such ratings are acquired via ePlow™ survey in follow-up to a snow removal. Such a rating system will be visible to others allowing consumers' advance understanding and review of potential operators prior to a snow removal agreement.

Independent Operators, on their JO Profiles, have their ePlow™ experience listed, for example, by the number (or percentage) of total jobs accepted versus refused and the reasons for post-inspection job refusal are listed by percentage.

Transparency of Access. As a condition of ePlow™ enrollment, Independent Operators must indicate, according to Google mapping technology, that they are immediately available for “on demand” snow removal. Available operators have their location projected on-line to their potential customers.

Accordingly, for independent operators with ePlow™, include but are not limited to:
Profile. Directly profile company information and services to the on-line public
Grow. Increase market access to new clients (growing their respective customer base)
Profit. Increase subsequent revenues
Improve. Receive direct feedback from customers on satisfaction and performance that will enable improvement in future service delivery
Educate. Grow customer perception for necessity of qualified snow removal operators (Only incorporated, licensed, & insured operators)
Fleet Efficiency. Through use of ePlow™, an Independent Operator may improve the efficiency of their fleet deployment. ePlow™ will allow Independent Operators to view the positioning of their respective snow removal fleet real-time via GPS/Mapping. ePlow™'s On-Demand services will enable efficient routing to the nearest customer.
Condition Predictability & Preparedness. Advance and “real time” weather data, relevant to the needs of Independent Operators, will permit adaptation to changing conditions
Administration/Organisation. Each Independent Operator is able to review their list of ePlow™-initiated customer contracts
Marketing. As part of the ePlow™ network, ePlow™'s customers will be continually engaged via email/social media etc. for seasonal specials, reminders for contracts. Being connected to ePlow™'s vast customer database and marketing network will benefit Independent Operator's business.
   Comply with Authorities. Allowing tracking of operator status of licensing and insurance certifications, reminders for renewal, and Advance Taxation Preparation and Organisation, wherein all taxation-relevant documentation is collated, organized, and presented by ePlow™ to independent operators for ease of preparation of corporate taxes. Additionally data such as taxation number is tracked where the taxation service may be provided through partnership with taxation/accounting software experts.

Within the description users are able to manage aspects of their interactions with Independent Operators by the establishment of user specific information and features. For example, the timing specification may be established in ePlow™ at three different options. Optionally, more or less may be provided. Accordingly, with three levels the user has the option to select:
“On Demand—Express Service” (visit/snow removal within 1 hour and premium pricing applies);
“On Demand—Same Day Service” (visit/snow removal by predetermined time same day); and
“On Demand—Other Timing Request” (which accommodates customers who aren't in immediate rush but expect snow removal by a specified date, e.g. a city resident on Monday wants second vacation property clear by the upcoming weekend for example) where the user specifies date/time information.

It snows or it doesn't snow but there is “existing” snow on the ground and the customer decides they want their driveway and/or walkway cleared in a single job execution therein selecting the “On Demand” service for a visit/snow removal within 1 hour. The customer may warrant that sufficient space exists on the property immediately adjacent to the driveway for safe snow removal thereby allowing the Independent Operator to know that the job can be performed with an anticipated level of simplicity.

In order to request the service, for a new customer, they proceed to Customer Registration and opens an account. Subsequently they enter details, including but not limited to:
Private location for snow removal (residence or commercial property); and
Credit card information (number, expiry, security code) which may for example be captured through an image of their card taken using a smartphone camera, for example, and their credit card information is automatically uploaded with their registration.

Next the customer submits a Snow Removal Request wherein information, including but not limited to, is provided by the consumer through the ePlow™ service to the Independent Operator to set expectations for the circumstances of the property upon arrival. Within some embodiments of the invention this information is not used within a pricing formula although within others it may be used to automatically generate a quotation or estimate for the customer.

One such item is the Submit Driveway Specification where it would be beneficial for the customer to have a simple method for determining/measuring the dimensions of the driveway to be plowed. This should, be “consumer friendly” and intuitive whilst also being sufficiently descriptive and accurate for the Independent Operator to believe in the principle of “fairness”—that their respective effort in preparation for and execution of the job is sufficiently rewarded by the compensation

Examples of potential measuring techniques include:
Simple Measurement: provided by (a) Estimated Driveway Size and (b) Estimated Depth of Snow;
Driveway Size: wherein the measurement of driveway size for the consumer may be specified in a manner of “Number of Standard Cars”, for example. For instance the customer may be asked to “Enter ‘Number’ of Standard Cars that could fit in your laneway” end-to-end and side-to-side” together with the approximate depth of snow;
Camera Image(s): wherein the customer provides images of the driveway area requiring snow removal;
Easy Measure.com: wherein a smartphone application measures dimensions of space through the smartphone's camera;
Google Streetview: wherein the Google Streetview imaging technology is exploited to view the actual property at street level.

Additional questions may be subsequently provided, such as:
Are there any barriers or issues relating to operator access?
Is the driveway paved with asphalt, bricked, cement?
Is snow fresh-fallen, on ground <1 week, >1 week?

The measures described above for driveways could equally apply to walkways, parking spaces, access ways and other areas requiring snow removal. However, walkway specifications have the potential to be much more variable in nature, e.g. length, width, surface, corners, stairs, multiple entrances to a home/shed etc., and therefore may or may not be more difficult to quantify via a standardized measure as that previously mentioned in driveway specifications. Clearing walkways is a service many consumers may value as it enables safe/easy access travel while on personal property. However, walkway clearance often requires additional equipment (i.e. snow blower/shovel), manual labour (beyond a tractor/truck required for a driveway), thereby potentially limiting the options for Independent Operators.

Due to the variable nature/size of walkways, accurate descriptions are probably more necessary and may be selected/data entered through such as for example, “Is there an adjacent walkway you would like cleared? (Y/N)”, “Enter Approximate distance (meters) of walkway requiring clearance”, and “Does walkway abut highway (Y/N).” Alternatively, the user may be request to submit photographs of the requiring walkway snow removal including those taken during a period without snow cover. A different pricing model for the walkway may be quoted than the driveway. For example, a user may be charged a $5 minimum plus a “time premium” (e.g. $5 per 15 minutes of activity that will be determined after completion of the snow removal).

Beneficially, the customer is notified in payment terms in a manner that is simple and transparent. Whereas some activities such as plumbing repair may be simply quoted based upon an estimate of time other activities may require a more complex calculation. For example, with snow clearing through ePlow™ a line-itemized approach to pricing may be employed, although other models may be applied without departing from the scope of the invention. For instance:

Driveway Clearance (1) Driveway Size “# of Cars” x (2) Depth of Snow

+ Walkway Clearance
+ Special Circumstances Premium

=========================
Total Charge

In some circumstances a minimum $30 base fee may be applied, assuming for example a driveway for parking 4 cars or less, with 1 foot of snow or less.

A “Special Circumstances Premium” may be applied for “special circumstances” or difficult features of the property, e.g. hill slope, tree location, weather conditions, etc., could increase snow removal costs beyond a standard ePlow™ snow removal. These features are unique to each property and impossible for ePlow™ to standardize through pricing. To compensate for additional challenges/costs to snow removal, the customer has the ability to voluntarily enter an additional dollar amount, over and above ePlow™'s formula pricing, that they would be willing to pay to accommodate the special conditions.

Upon site inspection, if the Independent Operator feels that the total dollar amount offered does not adequately compensate for the additional challenges or “special circumstances” of the requested, the Independent Operator may refuse service and leave the customer's premises. They then subsequently indicate in feedback through ePlow™'s “Rationale for Refusal” feature that the price was inadequate for the job specified. The Independent Operator would then specify an appropriate “special circumstances” premium for the features of the job required. The customer would be notified of this feedback as guidance to readjust their premium but they are not obligated to do so. However, this “suggested premium” and feedback would be available to other Independent Operators so it is in the best interest of the consumer to consider a mutually-agreeable “special circumstances premium”.

Optionally, ePlow™ allows for the possibility to adjust pricing for “Special Circumstance Premiums” either “on site” or by allowing telephone contact between the consumer and Independent Operator. Common to embodiments of the inventions within different immediate service activities is the expectation that because both customers and Independent Operators will be multiple users of services, e.g. ePlow™. Accordingly, there is a natural incentive by both parties to propose and mutually agree to an accurate, situation-representative price. Unfair pricing practices, by either party, will negatively influence their reputation through subsequent satisfaction and performance ratings on their respective customer/operator profiles. Negative experiences and ratings increase the likelihood that future transactions will be adversely affected, either by Independent Operator's refusal of service or Customers' selection of alternative Independent Operators. ePlow™ as a Connect Technology provider does not have the mandate to police individual transactions but by making the service users accountable to each other over time with trackable past behavior the accountability or “moral hazard” of “Open Source” market pricing will, over time, ensure fair market value. Customers also have the option of Contract Pricing.

Within the software embodiments of the invention, the customer has the ability to select the Independent Operator. For example, the customer selects the “ePlow™ Me” button within a web-based application wherein according to an embodiment of the invention, a map appears, e.g. Google™, Bing™, Yahoo™ for example. This map shows the real-time locations of immediately-available ePlow™-registered Independent Operators as icons. The icons (buttons) may be colour-coded, shaped-coded or otherwise coded as known within the art to identify separate classes of Independent Operators. For example, “Green” icons may indicate plowing equipment associated with an Independent Operator previously used by the customer. Remaining, “White” icons inform the customer of locally active snow plowing equipment relating to an Independent Operator that they have no prior experience with.

The customer can touch each “Independent Operator” button shown to immediately review the “Independent Operator Profile” information as previously outlined wherein the customer may either “Select” the vendor of their choice from the profile page by selecting “Choose Me” or may return to the Google Map and select “Closest Available Operator”. Optionally, touching a button indicating a previously used Independent Operator may provide details of the last service provided together with a summary profile rather than the standard profile page. As indicated supra, the models of immediate service provisioning according to embodiments of the invention are based upon time honoured principles of transparency, honesty, and integrity. Accordingly, the aforementioned “job” specifications entered by the customer represent at best the existing conditions expected at the property indicated. However, the Independent Operator upon visiting the customer property, has the right to both validate the conditions specified and accept/refuse to offer their service due to either misrepresentation or safety concerns. If refused, a description of the reason will be provided, time-stamped, and associated with the customer's profile in future. Equally, failure of the Independent Operator to visit, complete the “job” etc. will be transparently evident to other existing/potential customers.

Once the snow removal request is submitted, a text/web message is sent to the appropriate Independent Operator. Because the Connect Technology provided according to embodiments of the invention ensures a match of snow removal capabilities with property specifications, the Independent Operator should in principle have no reason to refuse service upon receipt of snow removal request. Accordingly, within embodiments of the invention they must visit a site for an inspection in order to refuse an offer and there may be limited predetermined options for a list of refusal reasons available to an Independent Operator in providing the feedback.

Upon a site visit inspection by an Independent Operator then they may accept the service request or they may refuse the service. As indicated upon a refusal they must specify, for example via a combination of drop down menus, i.e. snow amount>expected, slope dangerous, icy footing, blocked driveway, etc., or free text options. Optionally, the Independent Operator may append an image or images, video, etc. to reflect the conditions present upon their site visit. This information is time-stamped, provided to the customer via a notification to email address/phone number provided by the customer and attached to the customer and/or Independent Operator profiles. In order to attempt to limit against the potential for property “selection bias” the Independent Operators, on their IO Profiles, have their ePlow™ experience listed as a reflection of dependability, i.e. the number (or percentage) of total jobs accepted versus number offered. Similarly, the refusals post-inspection may be categorized and listed by percentage in order from most to least common. It is noted that in many instances a valid reason can be that the Independent Operator was due to unforeseen issue(s) to attend within the time window provided. In order to establish honesty in such instances the Independent Operator's GPS logs will be assessed to determine whether they were legitimately late or in fact attended and sought to reduce the negative impact on their profile by selecting this option, went to another job etc.

Once an Independent Operator accepts the service request then message confirmation is provided to the Independent Operator and the customer. In this manner an Independent Operator with multiple snow plow teams active may have record of the activities agreed to by its operators or a roaming supervisor (for example) wherein this communication includes details of the agreed task so that each party is aware of the scope of the work. In the instance that an Independent Operator has a roaming supervisor/assessor accepting requests for site visits and confirming tasks then the ePlow™ software may provide for the supervisor/assessor to assign a snow plow team or the ePlow™ software will automatically assign the activity to the nearest snow plow team of that Independent Operator.

Upon completion of the agreed task the Independent Operator may indicate its completion wherein the customer is notified via an electronic message of the activity completion. In instances where the customer is not physically present or the request is performed to a location remote of the customer ahead of their arrival then the Independent Operator may include image/video based confirmation. In this manner, if the customer requests clearance for 6 pm Friday evening and the Independent Operator clears it at 4 pm but there is a large snowfall then the Independent Operator should not be penalized. However, if they do the clearing on the Monday it is requested for a Friday evening and there is snow then the Independent Operator is responsible for the re-clearing after a snowfall.

Payment for the service provided by the Independent Operator may be triggered through a series of different options. In one embodiment of the invention the Independent Operator indication of a completed job triggers the debiting of the customer's credit card, or other financial instrument supported by the ePlow™ system according to embodiments of the invention. These funds are then transferred and distributed between the ePlow™ service and the Independent Operator according to the terms of their commercial agreement which may be, for example, fixed cost per request completed or percentage of Independent Operator revenue from ePlow™. Alternatively, the funds may be held in escrow pending confirmation from the customer that the service job has been completed. Optionally, the placement of the request by the customer triggers a hold onto their credit card or financial instrument of a value commensurate with the scope of work. Accordingly, if $40 is the calculated amount the hold is set to $60. An escrow type service element provides a buffer between customer and Independent Operator in respect of payment.

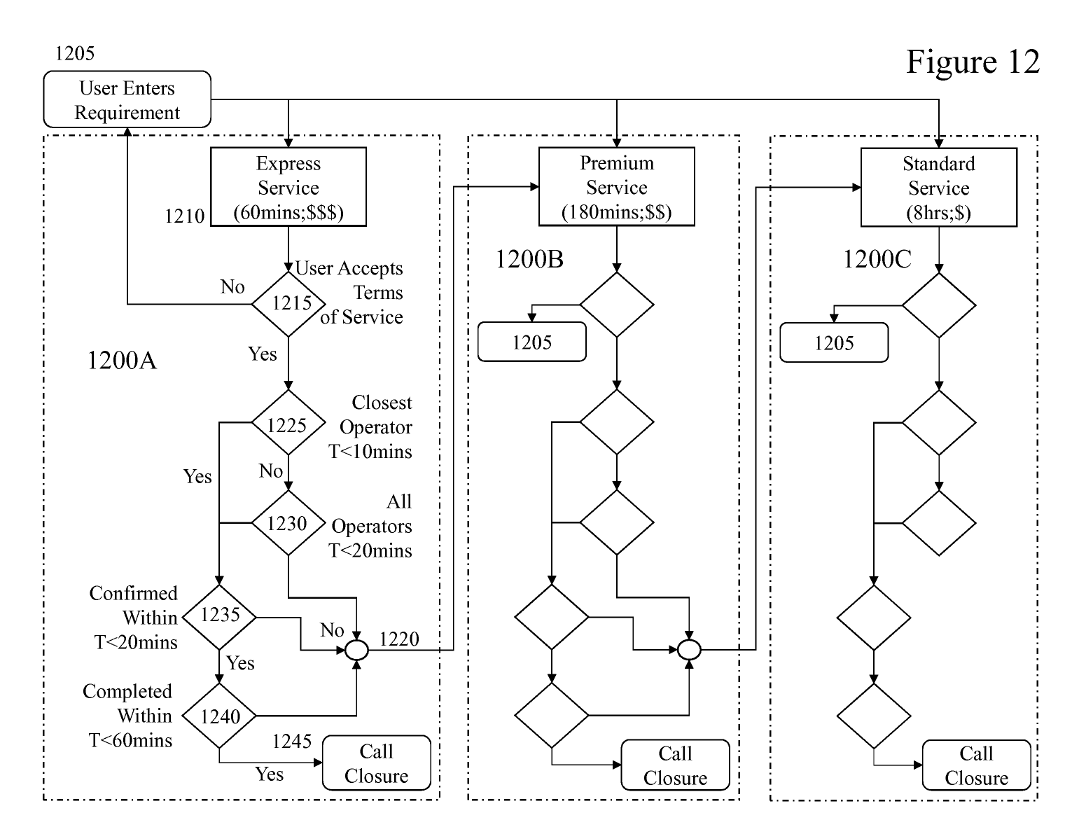

Now referring to FIG. 11, there is depicted an exemplary process flow for service call placement, fulfillment and dispute resolution according to an embodiment of the invention. As depicted, the process starts at step 1105 before a service call is placed in step 1110 by a customer as described according to embodiments of the invention above before in step 1115 the service call is accepted by a service provider, e.g. an Independent Operator, and then in step 1120 the service call is completed by the service provider. During this portion of the process all customer service related questions that are defined as field based and/or operator specific are handled exclusively by the Independent Operator, i.e. the service provider, who accepted the service call and confirmed completion of the service call. Full customer service contact information to reach Independent Operator (provided by the Independent Operator at registration) is accessible on the customer portal and on the electronic confirmation of service notification sent to customers by the Connect Technology provider.

Upon completion of the service call a service delivery receipt is sent to the customer. If there is an issue with the service provided from the customer's viewpoint then the customer can make a claim using, for example a claim button within the electronic confirmation of the service notification provided, for example, by email, text, or via a software application relating to the Connect Technology provider. If a claim is made as determined in step 1130 then the process flows to step 1140 otherwise the process proceeds to step 1135 and stops. In step 1140 a determination is made as to whether the claim is made within a predetermined time limit, e.g. 48 hours. Irrespective of the claim then if the customer has questions related to website functionality, payment processing, privacy etc. then they can contact the Connect Technology provider via email.

If the claim is made within the predetermined time limit then the process proceeds to step 1145 wherein billing is “suspended” until claim is settled, i.e. the billing transaction is not processed, and a status of service call changes from “complete” to “suspended.” At step 1150 resolution of the claim is made wherein the Independent Operator must re-submit a new service call such that the process returns to step 1120 wherein once the Independent Operator has completed the new service call then a new service delivery confirmation notice will be sent the customer) in order to reset the service call status back to “complete.” In this manner an additional 48 hour “customer claim period” may be automatically applied each time a call is submitted as complete as per the Connect Technology provider payment policy.

If the claim was made outside the predetermined time limit than the billing has not suspended and has been processed wherein the process proceeds to step 1160 wherein the customer engages the Independent Operator directly such that at step 1165 a determination is made as to resolution wherein the process subsequently proceeds to step 1170 wherein the dispute is resolved and the Independent Operator advices the Connect Technology provider of this or the process proceeds to step 1175 with alternate resolution, e.g. Courts, arbitration, etc. In each instance the process proceeds subsequently to step 1135 and stops. In this manner in step 1170 the Independent Operator may issue a full or partial refund by contacting the Connect Technology provider directly who then processes the refund such that funds are credited back to customer, e.g. repaid to their credit card.

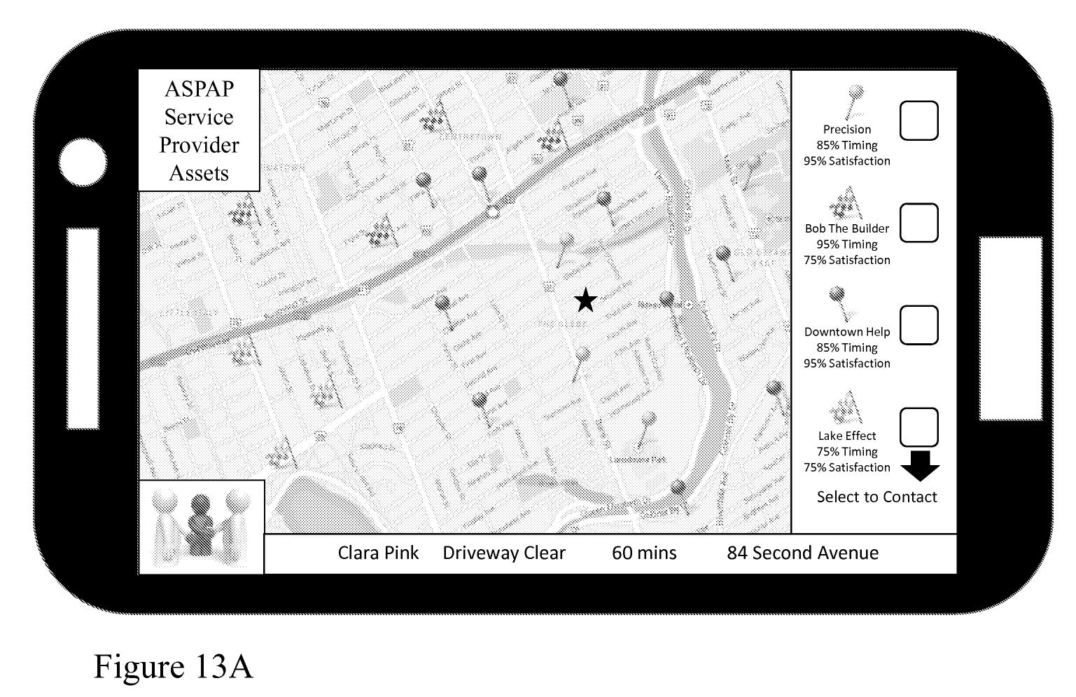

Now referring to FIG. 12, there is depicted an exemplary process flow for service call placement based upon service level and service roll-over according to an embodiment of the invention. Accordingly, the process starts at step 1205 wherein the user enters their requirement and selects a service level, e.g. Express, Premium, or Standard which may have varying remuneration levels for the Independent Operator. Accordingly, the process proceeds to either first sub-flow 1200A for Express service, second sub-flow 1200B for Premium service, and third sub-flow 1200C for Standard service. It would be evident that the number of service levels may be varied according to the service type, location, Connect Technology Provider, etc.

Considering, the instance that the customer in step 1205 selects Express service then the process proceeds to first sub-flow 1210 wherein the customer confirms this selection and the process proceeds to step 1215 and determines whether the customer accepted the terms of service. If not the process returns to step 1205 otherwise it proceeds to step 1225. In order for an Independent Operator to qualify for providing the Express service at the Express service rate they must agree that an Express service call must be confirmed within 20 minutes and the Express service call must be completed within 60 minutes of the “service delivery request” being made by the customer irrespective of when the Independent Operator confirms within their 20 minute window.

Accordingly, in step 1225, the ASPAP SSSA geo-locates the closest Independent Operator and notifies them of the customer service call wherein if they reply positively within 10 minutes the process proceeds to step 1235 otherwise it proceeds to step 1230 wherein all available Independent Operators are engaged for the next 10 minutes. A positive response from any of the available Independent Operators within this period results in the process proceeding to step 1235 otherwise it proceeds to step 1220. If at step 1235 a confirmation is not provided to the customer within 20 minutes for any reason the process proceeds to step 1220. If a confirmation was provided within 20 minutes then the process proceeds to step 1240 wherein a check is made as to whether the service call is completed within 60 minutes or not. A positive determination results in the process proceeding to step 1245 and call completed process is executed involving closure of the call within the ASPAP SSSA and the customer is emailed the confirmation of call completed.

If the process proceeds to step 1220, either because no Independent Operator confirms with 20 minutes, no Independent Operator responds at all, or the call is not completed within the 60 minutes established for the Express service then according to the terms of service accepted by the customer it proceeds to step 1250 in second sub-flow which relates to a Premium service wherein the time limits are longer set at, for example, 30 minutes for the closest geographic Independent Operators, 30 minutes for all Independent Operators such that the confirmation/acceptance time is now 60 minutes rather than 20 minutes and the service period is 3 hours rather than an hour. Second sub-flow 1200B proceeds essentially in the same manner as first sub-flow 1200A and again a failure to execute within the time limits triggers the process proceeding to third sub-flow 1200C wherein the service call should be confirmed within 3 hours and the service delivered within 8 hours. It would be evident, that in the event the customer selects the Premium service the process follows initially through second sub-flow 1200B before entering third sub-flow 1200C or if they select the Standard service it flows only through third sub-flow 1200C.

It would be evident to one skilled in the art that optionally the process flow depicted in FIG. 12 may include additional steps or omit some steps. Optionally, some steps may include additional elements such as step 1225 in first sub-flow 1200A or its equivalents in second and third sub-flows 1200B and 1200C respectively. For example, the user have select an Independent Operator at the time of placing their service call (order), have a pre-selected “preferred operator”, have an operator issued Loyalty coupon which directs the call to issuer, etc. such that it is the absence of one of these that triggers the default call being sent to closest operator for 10 minutes followed by all available. It would also be evident that according to an alternate embodiment of the invention additional Independent Operator monitoring algorithms may be in executions within an ASPAP SSSA according to embodiments of the invention such that, for example, failure by an Independent Operator to fulfill a target completion rate of Express service calls accepted may be removed from the available operators presented to a customer. Similarly, thresholds for completion etc. may be monitored, established etc. for other service levels and used as basis of including the Independent Operators within service categories. In other embodiments of the invention the timings of Independent Operators in respect of responding to service calls, completing service calls etc. may be provided as a basis for a customer to select Independent Operators or filter a sequence of Independent Operators.

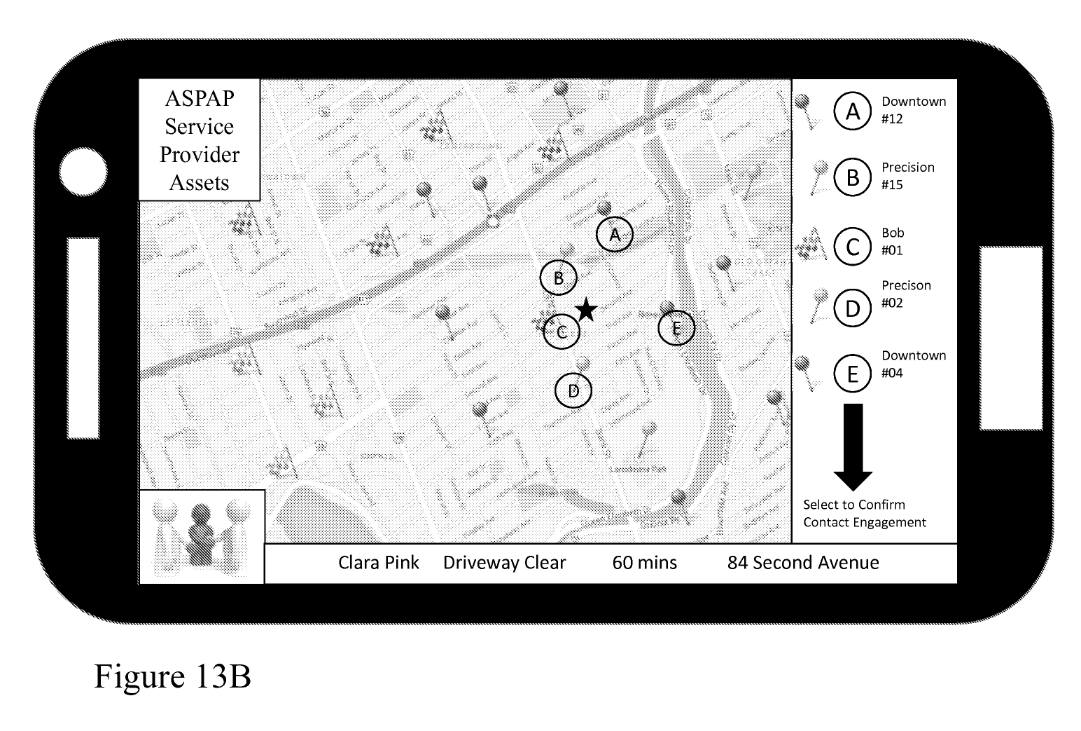

Now referring to FIGS. 13A and 13B, there are depicted first and second smartphone screen mockups for an ASPAP SSSA presenting map interfaces to a user for Independent Operator selection with respect to a service request. Referring to FIGS. 13A and 13B a user “Clara Pink” wishes to have a “Driveway Clear” service request completed within “60 mins” at “84 Second Avenue.” Accordingly, the map depicts the location of the service request with a star icon and depicts the locations of assets relating to different service providers capable of addressing the service request within the prescribed period. Within an embodiment of the invention as depicted in FIG. 13A, a user interface presents the user with the names of service providers, e.g. “Precision”, “Bob the Builder”, etc. associated with the different Independent Operators together with rating data such as, for example, prior customer ratings for timing and satisfaction with the service provided. Accordingly, the user is able to select the Independent Operator(s) who are to be contacted with respect to their service request. Alternatively, in FIG. 13B the user is able to select individual assets of different Independent Operators by tapping them upon the map wherein the user interface lists those tapped allowing the user to subsequently confirm as potentially a selected map stick pin relating to an asset of an Independent Operator is associated with an Independent Operator the user has in the past found to be unsatisfactory. In this instance the user interface identifies the specific asset rather than just the Independent Operator. Whilst in other embodiments these may be filtered through a setting of the user blocking certain Independent Operators in other instances these despite prior issues may be the only local Independent Operator.

In other embodiments, as described supra, in respect of FIG. 12 the Independent Operators may be automatically selected based upon the ASPAP SSSA establishing a geographical region based upon service level, for example. Optionally, the map interface may show the user that there are a limited number or no Independent Operators within range to provide the service at their initial preferred service level, e.g. Express, and accordingly, show the user the number of available Independent Operators within other service levels, e.g. Premium and Standard, thereby allowing them to initially select another service level with an initial management of expectations.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
providing a first user interface upon an electronic device comprising at least a microprocessor allowing a user to enter a time-sensitive requirement;
providing a second user interface allowing the user to establish a plurality of service providers to whom the time-sensitive requirement should be communicated;
transmitting data relating to the time-sensitive requirement and the plurality of service providers to a computer server via a network;
automatically with the computer server distributing to the plurality of service providers a first message relating to the time-sensitive requirement using at least one communications protocol of a plurality of available communications protocols;
receiving with the computer server at least one of a first response relating to a service provider's ability to fulfill the time-sensitive requirement and a second response relating to a service provider declining to address the time-sensitive requirement.

2. The method according to claim 1, wherein
the first message is provided using communication protocols for each service provider matching all contact means listed for the service provider within a directory of service providers.

3. The method according to claim 1, further comprising;
receiving as part of the time-sensitive requirement a time limit; and
generating a list of service providers for presentation to the user as part of the second user interface, each service provider within the list of service providers being one having at least one of a stored and a current indication of an ability to complete the time-sensitive requirement within the time limit.

4. The method according to claim 1, further comprising;
receiving as part of the time-sensitive requirement a time limit; and
generating a list of service providers for presentation to the user as part of the second user interface, each service provider within the list of service providers being one having a current geographic location compatible with being able to complete the time-sensitive requirement within the time limit.

5. The method according to claim 1, wherein
upon receiving no first response from any service provider of the plurality of service providers the method further comprises:
providing a third user interface allowing the user to establish a second plurality of service providers to whom the time-sensitive requirement should be communicated, wherein a time limit for completing the time-sensitive requirement has been increased from an initial time limit for completing the time-sensitive requirement established based upon data from the user or a service level selected by the user; and
automatically with the microprocessor distributing to the second plurality of service providers a second message relating to the time-sensitive requirement using at least one communications protocol of a plurality of available communications protocols.

6. The method according to claim 1, further comprising;
receiving at the computer server a second message relating to a selected service provider of the plurality of service providers relating to a service providers providing a first response, the second message relating to a completion of the time-sensitive requirement;
generating with the computer server a third message relating to the completion of the time-sensitive requirement and comprising a customer claim element allowing the user to indicate an issue with the completed time-sensitive requirement; and
automatically charging a financial instrument of the user a fee associated with the completion of the time-sensitive requirement if no indication of an issue is received within a predetermined period and delaying a charge to the financial instrument if an indication of an issue is received within a predetermined period.

7. A method comprising:
providing upon a computer server accessible via network a service to a user through an electronic device connected to the network, the service allowing a user to contact a plurality of service providers based upon their establishment of a requirement where each service provider is contacted according to the contact means identified by the service provider within a service provider directory stored upon the computer server, wherein the user specifies only the requirement and any applicable limits but does not format or generate any of the messages sent to the group of service providers by the service.

8. The method according to claim 7, wherein
the user provides to the service a voice message for use as a predetermined portion of a message contacting any service provider of the group of service providers listing telephony as a contact means.

9. The method according to claim 7, wherein
the computer server automatically distributes to the plurality of service providers a first message relating to the time-sensitive requirement using at least one communications protocol of a plurality of available communications protocols established by the service provider, wherein each service provider has previously indicated an ability to address such time-sensitive requirements; and
the computer server receives at least one of a first response relating to a service provider's ability to fulfill the time-sensitive requirement and a second response relating to a service provider declining to address the time-sensitive requirement.

10. The method according to claim 9, wherein
the first message is provided using communication protocols for each service provider matching all contact means listed for the service provider within a directory of service providers.

11. The method according to claim 1, further comprising;
receiving as part of the time-sensitive requirement a time limit; and
generating a list of service providers for presentation to the user as part of the second user interface, each service provider within the list of service providers being one having at least one of a stored and a current indication of an ability to complete the time-sensitive requirement within the time limit.

12. The method according to claim 7, further comprising;
establishing the plurality of service providers based upon a current geographic location of a service providing asset of a service provider being within a predetermined region defined relative to the user, the predetermined region defined by the service as being compatible with the service providing asset of the service provider being able to complete the time-sensitive requirement within the time limit.

13. The method according to claim 9, wherein
upon receiving no first response from any service provider of the plurality of service providers the method further comprises:
establishing a second plurality of service providers to whom the time-sensitive requirement should be communicated, wherein a time limit for completing the time-sensitive requirement has been increased from the initial time limit for completing the time-sensitive requirement established based upon receiving either a new time limit from the user or the service automatically selecting a service level below an initial service level selected by the user; and
automatically distributing to the second plurality of service providers a second message relating to the time-sensitive requirement using at least one communications protocol of a plurality of available communications protocols.

14. The method according to claim 9, further comprising;
receiving at the computer server a second message relating to a selected service provider of the plurality of service providers relating to the service provider providing a first response, the second message relating to a completion of the time-sensitive requirement;
generating with the computer server a third message relating to the completion of the time-sensitive requirement and comprising a customer claim element allowing the user to indicate an issue with the completed time-sensitive requirement; and
automatically charging a financial instrument of the user a fee associated with the completion of the time-sensitive requirement if no indication of an issue is received within a predetermined period and delaying a charge to the financial instrument if an indication of an issue is received within a predetermined period.

15. A method of providing to a user responses from a group of service providers based upon a user's previously established requirement where each service provider has been contacted according to the contact means identified by the service provider within a service provider directory where the user specifies the requirement and any applicable limits but does not format or generate any of the messages sent to the group of service providers and the responses are provided in a single user interface irrespective of the means each service provider contacts the user.

16. The method according to claim 15, wherein
the group of service providers was established based upon current geographic locations of service providing assets of each service provider of a plurality of service providers being within a predetermined region defined relative to the user, the predetermined region defined by the service as being compatible with the service providing asset of the service provider being able to complete the time-sensitive requirement within the time limit.

17. A method of allowing a user to select a service provider to perform a time-sensitive service request comprising:
providing to the user upon an electronic device a display comprising at least a map, the map comprising at least indicators relating to:
a location specified by the user at which the time-sensitive service request is to be provided; and
current geographic locations of service providing assets of each service provider of a plurality of service providers able to complete the time-sensitive requirement within a time limit established by the user relating to the time-sensitive service request.

18. The method according to claim 17, wherein
the determination of a service providing asset of each service provider of the plurality of service providers able to complete the time-sensitive requirement within the time limit is automatically determined by a service providing the map to the user based upon the service providing asset of each service provider of the plurality of service providers being within a predetermined region defined relative to the location established by the service, the predetermined region defined by a service as being compatible with the service providing asset of the service provider being able to deliver the time-sensitive requirement within the time limit.

19. The method according to claim 17, wherein
the determination of a service providing asset of each service provider of the plurality of service providers able to complete the time-sensitive requirement within the time limit is established by the service:
automatically distributing to the plurality of service providers a first message relating to the time-sensitive requirement using at least one communications protocol of a plurality of available communications protocols; and
receiving with the computer server receiving at least one of a first response relating to a service provider's ability to fulfill the time-sensitive requirement and a second response relating to a service provider declining to address the time-sensitive requirement.
